(19) United States
(12) Patent Application Publication
(10) Pub. No.: US 2011/0235861 A1
(43) Pub. Date: Sep. 29, 2011

(54) METHOD AND APPARATUS FOR ESTIMATING ROAD SHAPE

(75) Inventor: Naoki NITANDA, Anjo-shi (JP)

(73) Assignee: DENSO CORPORATION, Kariya-city (JP)

(21) Appl. No.: 13/053,309

(22) Filed: Mar. 22, 2011

(30) Foreign Application Priority Data
Mar. 23, 2010 (JP) 2010-066715

(51) Int. Cl. G06K 9/00

(52) U.S. Cl. 382/103

(57) ABSTRACT

An apparatus estimates a shape of a road on which a vehicle travel. The apparatus id mounted on the vehicle. In the apparatus, information indicative of a plurality of detection points is received through transmission and reception of electromagnetic waves. The detection points are given as a plurality of candidates for edges of the road. It is determined whether or not a distance between each detection point and the vehicle is equal to or larger than a predetermined value. A first approximated curve for each detection point having the distance equal to larger than the predetermined value is detected, and a second approximated curve for a detection point having the distance less than the predetermined value is detected. The shape of the road is estimated by merging the first and second approximated curves.

### CROSS-REFERENCE TO RELATED APPLICATION

This application is based on and claims the benefit of priority from earlier Japanese Patent Application No. 2010-066715 filed Mar. 23, 2010, the description of which is incorporated herein by reference.

### BACKGROUND OF THE INVENTION

1. Technical Field of the Invention

The present invention relates to a method and an apparatus for estimating the shape of a road on which the vehicle equipped with the system travels.

2. Related Art

A road-shape estimation system as mentioned above has been known. For example, JP-A-2005-172590 discloses such a road-shape estimation system in which detection points are detected by radar. Of the detected detection points, those which match geographical information are detected as being located on road edges to thereby estimate the shape of the road.

However, in estimating a road shape using the road-shape estimation system of the conventional art as mentioned above, correct geographical information is required. If the geographical information is different from the actual road shape, the road shape is unlikely to be correctly detected.

### SUMMARY OF THE INVENTION

Hence it is desired to provide a road-shape estimation system which is able to estimate the shape of the road on which the vehicle equipped with the system travels, with a simple configuration without using geographical information.

As one aspect, there is provided an apparatus for estimating a shape of a road on which a vehicle travel, the apparatus being mounted on the vehicle. The apparatus comprises first receiving means for receiving information indicative of a plurality of detection points which are given as a plurality of candidates for edges of the road viewed forward from the vehicle, by transmitting an electromagnetic wave toward a space viewed forward from the vehicle and receiving a reflected wave of the transmitted electromagnetic wave; determining means for determining whether or not a distance between each of the plurality of detection points and the vehicle is equal to or larger than a predetermined value; first detecting means for detecting a first approximated curve for each of a plurality of detection points having the distance equal to larger than the predetermined value among the acquired plurality of detection points; second detecting means for detecting a second approximated curve for each of a plurality of detection points having the distance less than the predetermined value among the acquired plurality of detection points; and estimating means for estimating the shape of the road by merging the first and second approximated curves detected by the first and second detecting means.

According to the road-shape estimation system, a road shape is detected only based on detection points. Accordingly, compared with the case where geographical data, for example, are required, a road shape is estimated (or recognized) with a simple configuration. Also, according to the road-shape estimation system, a plurality of approximated curves are calculated by dividing a region into blocks according to the distance from the vehicle to detection points. Accordingly, compared with the case where an entire region is detected as a single approximated curve, an approximated curve in a narrow region can be detected.

Thus, when a road shape changes between a region where an approximated curve is detected by the long-range approximated curve detecting means and a region where an approximated curve is detected by the short-range approximated curve detecting means, an approximated curve is separately detected for each of these regions. Accordingly, the influence in the change of road shape is mitigated. As a result, the accuracy in detecting an approximated curve is enhanced.

According to the present invention, the fact that a curve, a slope, or the like, is present in a distance or the fact that a road shape changes can be detected with good accuracy.

In the foregoing basic configuration, it is preferred that the first detecting means includes mans for plotting, every one of the detecting points, combinations of a plurality of constants available in a predetermined function indicating an approximated curve passing through each of the detection points, in a voting space defined by axes representing either values of the constants or values related to the constants; and means for obtaining the approximated curve by performing a voting process in which a combination of the constants whose plots has the highest density in the voting space is employed as the first approximated curve for each of the detection points.

According to the road-shape estimation system, by performing voting, detection points not indicating road edges are effectively removed to obtain only the detection points indicating road edges. Accordingly, accuracy is enhanced in detecting an approximated curve that indicates a road edge. Also, in performing voting, it is not necessary to identify whether a detection point indicates a pedestrian, a vehicle, a road edge, or the like, whereby the processing of voting is simplified.

It is also preferred that the voting process includes a first voting process detecting a first-order curve in a first voting space and a second voting process detecting a second-order curve in a second voting space, the first-order and second-order curves belonging to the approximated curve, the first and second voting spaces belonging to the voting space, and the obtaining means is configured to employ, as the first approximated curve, the combination of the constants whose plots has the highest density in both the first and second voting spaces.

According to the road-shape estimation system, a road shape is identified to be straight or curved.

It is also preferred that the apparatus comprises second receiving means for receiving information indicative of behavior of the vehicle, wherein the second detecting means includes means for estimating, as the second approximated curve, a position of the second approximated curve where the first approximated curve detected by the first detecting means in the past approaches the detection points while the vehicle travels, based on the received information indicative of the behavior of the vehicle, and means for employing the second approximated curve based on an estimated position of the second approximated curve.

According to the road-shape estimation system, an approximated straight line in a short-range region (region whose distance from the vehicle is less than a predetermined value) is detected with simple processing.

Still preferably, the first receiving means is configured to repeatedly receive the information indicative of the plurality of detection points, the apparatus further comprising second receiving means for receiving information indicative of behavior of the vehicle; calculation means for calculating an amount of travel of the vehicle during a period of time from a past detection time of each of the detection points to a latest detection time of each of the detection points, based on the received information indicative of the behavior of the vehicle; correction means for positionally correcting the past detection points based on the calculated amount of travel of the vehicle; and superposition means for superposing the positionally corrected detection points on the latest detection points.

According to the road-shape estimation system, moving objects, such as preceding vehicles and pedestrians, are lightly weighted because the positions of these objects will change, while stationary objects, such as road edges, are heavily weighted. As a result, the moving objects are easily removed in calculating an approximated curve.

It is still preferred that the first receiving means is configured to receive the information indicative of the plurality of detection points, the information being detected by intermittently transmitting an electromagnetic wave ahead of the vehicle to scan a given spatial range ahead and viewed from the vehicle and receiving a reflected electromagnetic wave thereof, the apparatus further comprising second receiving means for receiving information indicative of behavior of the vehicle; travel amount calculating means for calculating, every time when the electromagnetic wave is transmitted, an amount of travel of the vehicle during a given interval of time including at least a time necessary from transmitting the electromagnetic wave to receiving the reflected electromagnetic wave, based on the received information indicative of the behavior of the vehicle; position correcting means for correcting the positions of the detection points depending on the calculated amounts of travel of the vehicle; and means for ordering the first and second detecting means to detecting the first and second approximated curves based on the corrected positions of the detection points.

For example, the road-shape estimation system may be used with a laser radar which is configured to obtain detection points by scanning a predetermined region in the forward direction of the vehicle while intermittently applying electromagnetic waves to the region and by receiving the reflected waves. Being used with a laser radar having such a configuration, the road-shape estimation system is able to correct the delay time caused in the detection and therefore the accuracy of detecting a road width is maintained.

### BRIEF DESCRIPTION OF THE DRAWINGS

In the accompanying drawings:

FIG. 1 is a schematic block diagram illustrating an estimation system in which a road-shape estimation unit of the present invention is applied;

FIG. 2A is a flow diagram illustrating a road-shape estimating process;

FIG. 2B is a flow diagram illustrating a range-data generating process;

FIG. 3 is a flow diagram illustrating a current-time data setting process;

FIGS. 4A and 4B are schematic diagrams illustrating a process of correcting a detection point;

FIG. 5 is a flow diagram illustrating a past data setting process;

FIG. 6 is an explanatory diagram illustrating a process of correcting time delay;

FIG. 7 is an explanatory diagram illustrating effects exerted by the correction of time delay;

FIG. 8A is a flow diagram illustrating a processing range setting process;

FIG. 8B is a bird's eye diagram illustrating a processing range;

FIG. 9 is a flow diagram illustrating a straight-line estimating process;

FIGS. 10A and 10B are schematic diagrams illustrating the straight-line estimating process;

FIG. 11 is a flow diagram illustrating a curved-line estimating process;

FIGS. 12A and 12B are schematic diagrams illustrating the curved-line estimating process;

FIG. 13 is a flow diagram illustrating a straight/curved-line determining process;

FIGS. 14A to 14C are schematic diagrams specifically illustrating the straight/curved-line determining process;

FIG. 15A is a flow diagram illustrating an estimation results merging process; and

FIGS. 15B and 15C are flow diagrams illustrating the estimation results merging process.

### DETAILED DESCRIPTION OF THE PREFERRED EMBODIMENTS

With reference to the accompanying drawings, hereinafter is described an embodiment of the present invention.

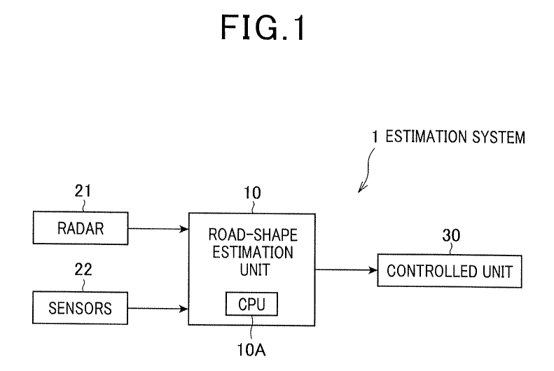

FIG. 1 is a schematic block diagram illustrating an estimation system 1 to which the present invention is applied. The estimation system 1 is installed in a vehicle, such as a motor car, and has a function of detecting the shape of the road (e.g., of distinguishing between a straight line and a curved line, and of detecting a curvature radius) on which the vehicle equipped with the system (hereinafter referred to “the vehicle concerned” or just as “the vehicle”) travels. Specifically, as shown in FIG. 1, the estimation system 1 includes a road-shape estimation unit 10, a radar 21, sensors 22 and controlled unit 30. In the road-shape estimation unit 10, the method and apparatus for estimating a shape of a road, which is according to the present invention, are functionally implemented.

The radar 21 is configured as a laser radar. The radar 21 scans a predetermined region in a traveling direction of the vehicle (forward direction in the present embodiment), intermittently applying laser beams, i.e. electromagnetic waves, to the region, and receives the reflected waves (reflected light) to detect targets, as detection points, which are located in the forward direction of the vehicle.

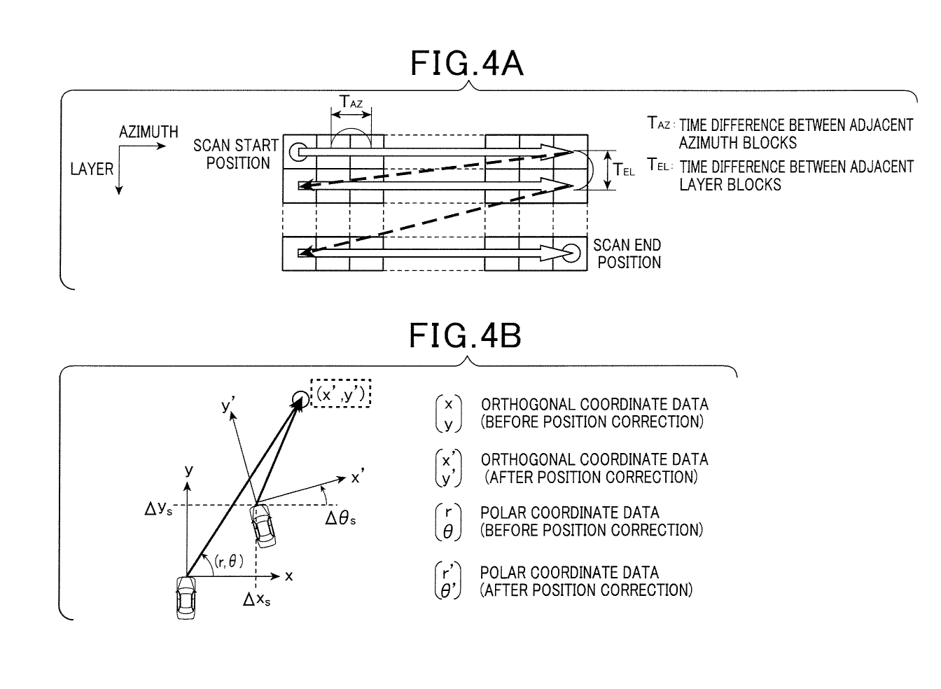

Specifically, the radar 21 applies laser beams from an upper-left corner to an upper-right corner, i.e. applies laser beams horizontally rightward, of the predetermined region that has been set as a region for applying laser beams. In applying laser beams to the predetermined region, the radar 21 changes the range of the horizontally-rightward application of the laser beams, while intermittently applying laser beams to the region at even intervals (even angles). When the laser beams reach the upper-right corner, the radar 21 changes the range of the horizontally-rightward application of the laser beams, to a lower range located lower than the upper-left corner by a predetermined angle, and resumes application of the laser beams (see FIG. 4A).

Repeating this action, the radar 21 sequentially applies the laser beams to the entire predetermined region. The radar 21 detects the positions of targets (detection points) every time the laser beams are applied, based on the timings of detecting the reflected waves and the directions of applying the laser beams. Upon completing scanning of the entire region, the radar 21 transmits position data of the detection points to the road-shape estimation unit 10.

The radar 21 is able to detect not only three-dimensional objects, such as guardrails, reflectors, wall surfaces and trees, but also planar objects, such as white lines and paints on the road. In detecting planar objects by the radar 21, a threshold may be set to a reflection intensity of a reflected wave and objects whose reflection intensity is larger than the threshold may be selected.

In the present embodiment, position data of a detection point is ensured not to be generated when laser beams are applied in a direction disabling reception of the reflected waves, such as toward the sky. This is for mitigating the processing load caused in a range-data generating process which will be described later. In this configuration, data is transmitted to the road-shape estimation unit 10 when the predetermined region has been scanned, the data containing information on the positions of detection points, which are equal to the number of detection points (constant “N” described later) received with the reflected waves. The radar 21 is configured so that the above process for detecting detection points is periodically (e.g., every 100 ms) performed.

The sensors 22 are each configured as a well-known sensor that outputs the detection results of the behaviors of the vehicle concerned. Specific examples of the sensors 22 may include a vehicle speed sensor that detects the traveling speed of the vehicle, a yaw rate sensor that detects an angular rate of turn of the vehicle, and an acceleration sensor that detects acceleration applied to the vehicle. The sensors 22 transmit the results of detection of the behaviors of the vehicle to the road-shape estimation unit 10.

The road-shape estimation unit 10 is configured as a well-known microcomputer that includes a CPU 10A and a ROM, a RAM (not shown), to perform various processes based on the program stored in the ROM 10A or the program loaded on the RAM. One of the processes performed by the road-shape estimation unit 10 is a road-shape estimating process that will be described later. In performing the various processes, the road-shape estimation unit 10 uses the results of detection acquired from the radar 21 and the sensors 22.

The road-shape estimation unit 10 estimates (or recognize) a road shape and uses the information on the estimated road shape to estimate the presence of a curve in a distance and a curvature radius of the curve. Then, the road-shape estimation unit 10 outputs the information to the controlled unit 30.

The controlled unit 30 is configured as a well-known microcomputer that includes a CPU, a ROM and a RAM to perform various controls upon reception of the information from the road-shape estimation unit 10. For example, the various controls include automatic cruising under which the accelerator, the brake and the steering wheel, for example, of the vehicle are automatically controlled, and drive assist under which warning is given to the driver or guidance is given to the driver for performing predetermined operations.

In particular, since the presence of a curve in a distance, for example, is estimated by the road-shape estimation unit 10, the controlled unit 30 is able to perform vehicle control according to the location of the curve. For example, the controlled unit 30 is able to decelerate the vehicle before entering the curve, or give warning or display information after making a comparison between the speed of the vehicle and a safety speed suitable for the curvature radius of the curve.

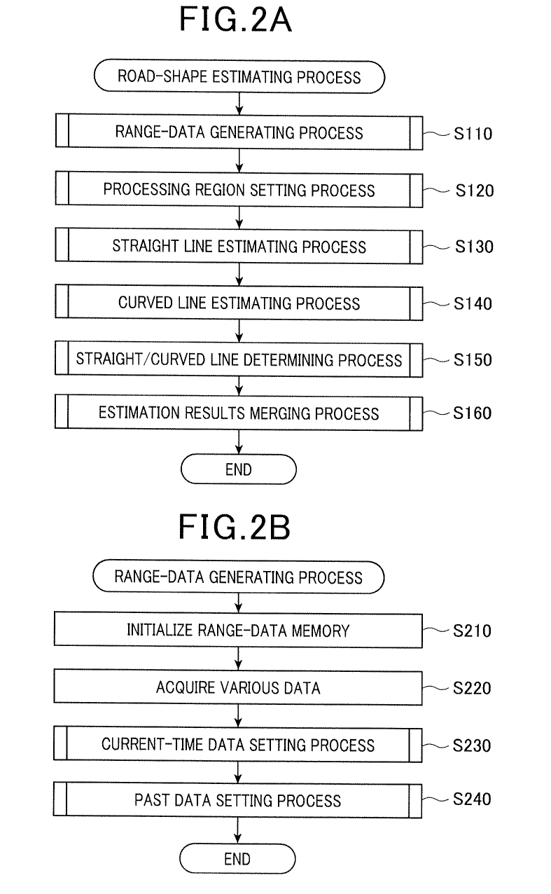

Referring now to FIGS. 2A and 2B as well as the subsequent drawings, hereinafter will be described processes for detecting a road shape. FIG. 2A is a flow diagram illustrating a road-shape estimating process performed by the road-shape estimation unit 10. FIG. 2B is a flow diagram illustrating a range-data generating process performed in the road-shape estimating process.

The road-shape estimating process is started, for example, upon application of power of the vehicle concerned, and then periodically (e.g., every 100 ms) repeated. Specifically, as shown in FIG. 2A, the following processes are sequentially performed, which are a range-data generating process (S110), a processing range setting process (S120), a straight-line estimating process (S130), a curved-line estimating process (S140), a straight/curved-line determining process (S150) and an estimation results merging process (S160). The processes at S120 to S150 correspond to the long-range approximated curve detecting means.

The range-data generating process includes correcting delay caused by the scanning of the radar 21 and superposing the detection points detected in the past on the detection points detected this time while the positions of the past detection points are corrected. Specifically, as shown in FIG. 2B, range data in the RAM are initialized (S210), first, followed by acquiring various data (S220: detection point receiving means, behavior receiving means). The data acquired at S220 include data concerning the results of detection performed by the radar 21 for detection points and the results of detection performed by the sensors 22 for the behaviors of the vehicle.

Subsequently, a current-time data setting process (S230) and a past data setting process (S240: superposing means) are sequentially performed. After completing these processes, the range-data generating process is ended.

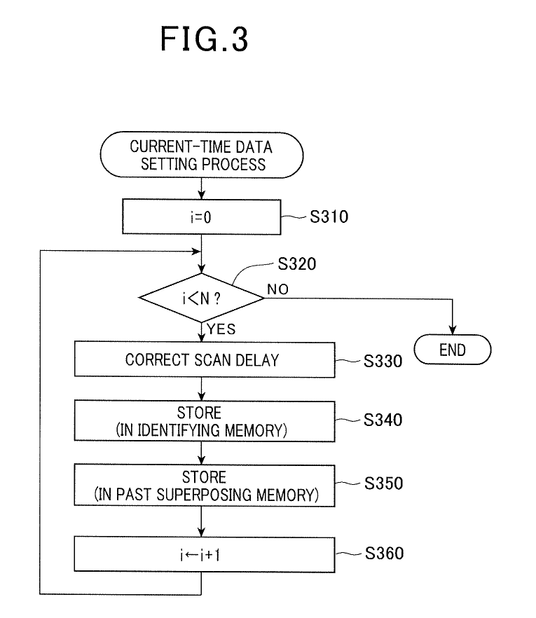

Referring to the flow diagram of FIG. 3, the current-time data setting process is described.

As shown in FIG. 3, in the current-time data setting process, a variable “i” is reset, first (set to zero) (S310), followed by comparing the variable i with a constant “N” (S320). The constant N indicates the number of total detection points that have been detected by one scanning of the radar 21.

If the variable i is equal to or more than the constant N (NO at S320), it means that correction of the positions of all the detection points has been completed, and thus the present process is ended. If the variable i is less than the constant N (YES at S320), an i^{th} detection point is selected to perform the process of correcting the position of the i^{th} detection point (S330: position correcting means).

Specifically, in this process, a travel distance of the vehicle from each time point of applying laser beams up to a time point of ending scanning is calculated based on the behaviors of the vehicle. Then, the position of each acquired detection point is corrected by an amount equal to the calculated travel distance of the vehicle. This process is specifically described referring to FIGS. 4A and 4B. FIGS. 4A and 4B are schematic diagrams illustrating a process of correcting the position of a detection point.

As shown in FIG. 4A, the entire region to which laser beams are applied by the radar 21 is divided into matrix blocks. In each horizontal row of blocks, one scanning is performed with the application of laser beams. Each of the blocks is numbered. In the horizontal direction, the blocks are sequentially numbered from the left to the right and these numbers are referred to “azimuth numbers”. In the vertical direction, the blocks are sequentially numbered from the top to the bottom and these numbers are referred to “layer numbers”.

In this configuration, each of the blocks to which laser beams are applied by the radar 21 is defined by an azimuth number and a layer number. It should be appreciated that the radar 21 applies laser beams to the blocks at a predetermined time interval.

On this premise, a time difference (time delay) from when laser beams are applied to a block having a certain azimuth number and a certain layer number until when laser beams are applied to a position where scanning is ended (scanning end position) is expressed by the following Formula (1).

ΔT=T_{AZ}×(total number of azimuth blocks−azimuth number)+T_{EL}×(total number of layer blocks−layer number) Formula (1)

where ΔT is a time delay caused before the time point when laser beams are applied to a position of ending scanning, T_{AZ} is a time difference from when laser beams are applied to a block having a certain azimuth number until when laser beams are applied to the adjacent block having a certain azimuth number (but having the same layer number), T_{EL} is a time difference from when laser beams are applied to a block having a certain layer number until when laser beams are applied to the adjacent block having a certain layer number (but having the same azimuth number).

Let us assume, as shown in FIG. 4B, that (x, y) is a coordinate (orthogonal coordinate) indicating the position of a detection point before correction, (x′, y′) is a coordinate (orthogonal coordinate) indicating the position of a detection point after correction, (r, θ) is a coordinate (polar coordinate) indicating the position of a detection point before correction as viewed from the vehicle, and (r′, θ′) is a coordinate (polar coordinate) indicating the position of a detection point after correction as viewed from the vehicle. Then, as shown in FIG. 4B, the coordinate (x′, y′) indicating the position of a detection point after correction is calculated by the following Formula (2).

$$\begin{matrix}( \begin{matrix}{x}^{′} \\ {y}^{′}\end{matrix} ) = ( \begin{matrix}cos Δ {θ}_{s} & sin Δ {θ}_{s} \\ - sin Δ {θ}_{s} & cos Δ {θ}_{s}\end{matrix} ) ( \begin{matrix}x - Δ {x}_{s} \\ y - Δ {y}_{s}\end{matrix} ) \\ = ( \begin{matrix}cos Δ {θ}_{s} & sin Δ {θ}_{s} \\ - sin Δ {θ}_{s} & cos Δ {θ}_{s}\end{matrix} ) ( \begin{matrix}r cos θ - Δ {x}_{s} \\ r sin θ - Δ {y}_{s}\end{matrix} )\end{matrix} \qquad Formula ( 2 )$$

where Δxₛ=x′−x, Δyₛ=y′−y and Δθₛ=θ′−θ. It should be appreciated that Δxₛ, Δyₛ and Δθₛ are calculated from the behaviors of the vehicle concerned (speed and yaw rate of the vehicle).

Since the radar 21 of the present embodiment has a comparatively high resolution, it is effective to perform the process of correcting the position of a detection point to achieve higher accuracy. In other words, if a detection system having a low resolution is used instead of the radar 21, the position of a detection point can no longer be accurately detected. In this case, it is difficult to enjoy the effects that would be obtained from the correction process described above.

After completing the process of correcting delay, the range data (data of a detection point after correction) regarding the i^{th} detection point are stored in an area in the RAM for storing range data (S340, S350).

In this case, the range data are stored in two areas, that is, an area for storing data for detecting a road shape regarding the current correction (identifying memory) and an area for storing data for detecting a road shape regarding the subsequent corrections (past superposing memory). It should be appreciated that the range data corresponding to maximum of K frames are stored in the past superposing memory, and that when the memory becomes full, the stored range data are overwritten in chronological order. The reference symbol “K” here indicates the number of frames (e.g., K=5) that can be stored in the past superposing memory.

Subsequently, the variable i is incremented (S360) and control returns to S320.

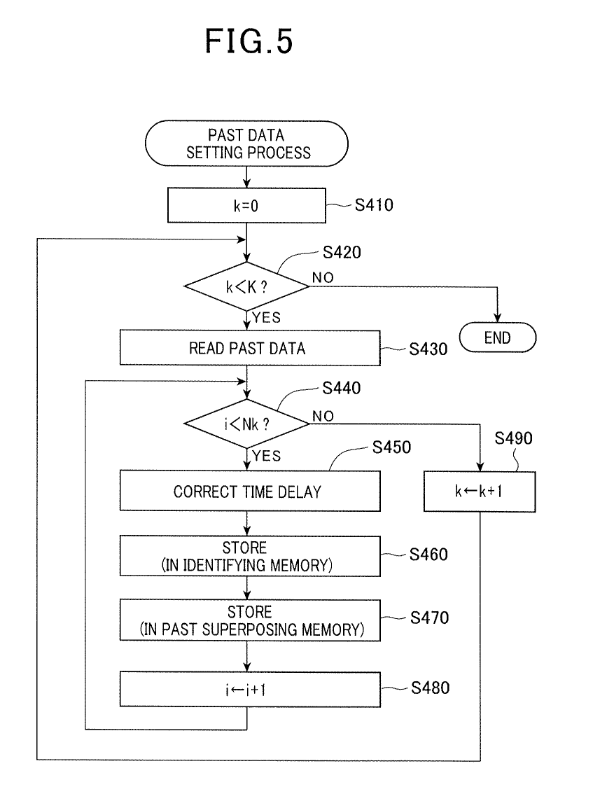

Referring now to the flow diagram of FIG. 5, hereinafter is described the past data setting process.

As shown in FIG. 5, in the past data setting process, a variable “k” is reset (S410), followed by comparing the variable k with a constant “K” (S420). The constant K here indicates the number of sets of range data (number of frames) recorded on the RAM (past superposing memory).

If the variable k is equal to or more than the constant K (NO at S420), it means that position correction of all sets of range data has been completed and thus the present process is ended. If the variable k is less than the constant K (YES at S420), a k^{th} set of range data is selected. Then, the range data of this set is read out and the variable i is reset (S430).

Then, the variable i is compared with a constant “Nk” (S440). The constant Nk indicates the total number of detection points regarding k sets of range data.

If the variable i is equal to or more than the constant Nk (NO at S440), it means that position correction has been completed for all of the detection points of the k sets of range data. Thus, the variable k is incremented (S490) and control returns to S420. If the variable i is less than the constant Nk, (YES at S440), an i^{th} detection point in the k sets of range data is selected to perform a process of correcting the position of this detection point (time delay correction) (S450).

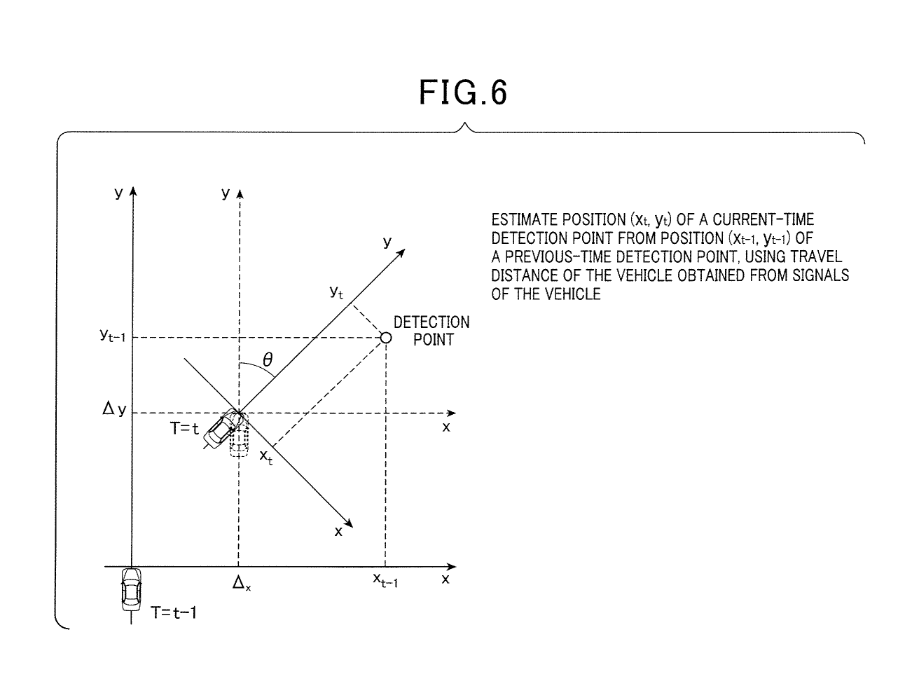

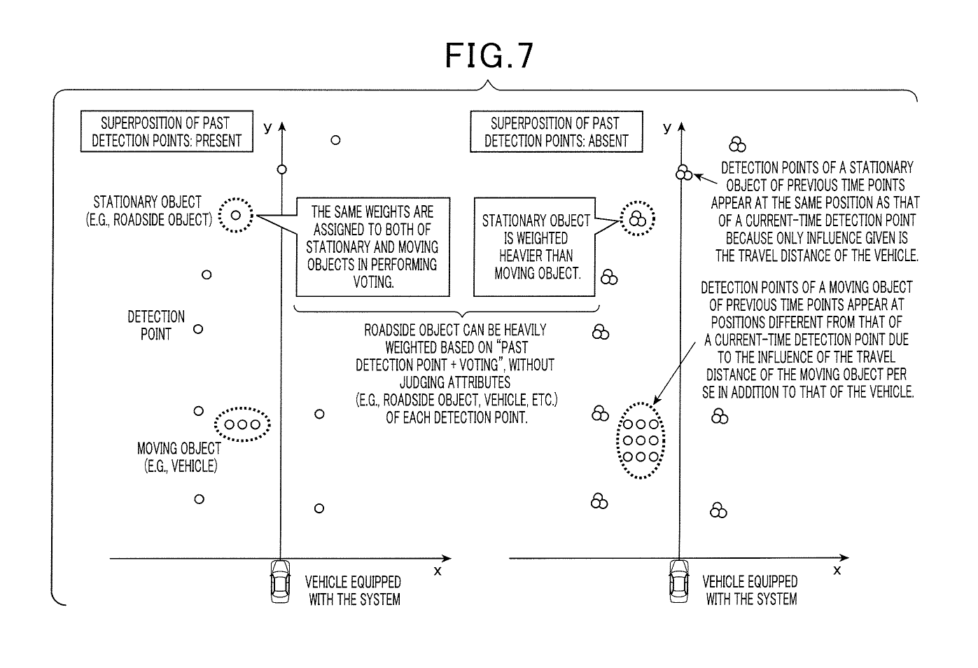

Referring to FIG. 6 and FIG. 7, herein after is described the process of correcting positions (time delay correction). FIG. 6 is an explanatory diagram illustrating a process of time delay correction. FIG. 7 is an explanatory diagram illustrating the effects exerted by the time delay correction.

In the time delay correction, a position (xₜ₋₁, yₜ₋₁) of a detection point at the previous time point is corrected to obtain a position (xₜ, yₜ) of the detection point at the current time point, based on a travel distance of the vehicle from the previous time point to the current time point. As shown in FIG. 6, the position of the detection point at the current time point is calculated by the following Formula (3).

$$\{ \begin{matrix}{x}_{t} = ( {x}_{t - 1} - {Δ}_{x} ) cos θ - ( {y}_{t - 1} - {Δ}_{y} ) sin θ \\ {y}_{t} = ( {y}_{t - 1} - {Δ}_{y} ) cos θ + ( {x}_{t - 1} - {Δ}_{x} ) sin θ\end{matrix} \qquad Formula ( 3 )$$

where Δₓ is a travel distance of the vehicle in the right-left direction from the previous time point to the current time point and, likewise, Δ_{y} is a travel distance in the front-back direction, and θ is a turn angle (which is positive in clockwise direction) of the vehicle.

When time delay is corrected for each of the detection points, the detection points at the previous time point are, as shown on the right of FIG. 7, regarded to be present together with the latest detection points. Thus, stationary objects located such as on a road edge are assigned with large weights, with the detection points at the previous time point being superposed by the latest detection points. On the other hand, moving objects are assigned with small weights, with the detection points at the previous time point and the latest detection points appearing at different positions. In this configuration, stationary objects are easily detected compared to the configuration in which the positions of the past detection points are not taken into account (see the left of FIG. 7).

After completing the time delay correction, the range data for the i^{th} detection point in the k sets of range data are stored in the area of the RAM where range data are stored (S460, S470). In this case, similar to the current-time data setting process, the range data are stored in two areas, that is, the identifying memory and the past superposing memory. Then, the variable i is incremented (S480) and control returns to S440.

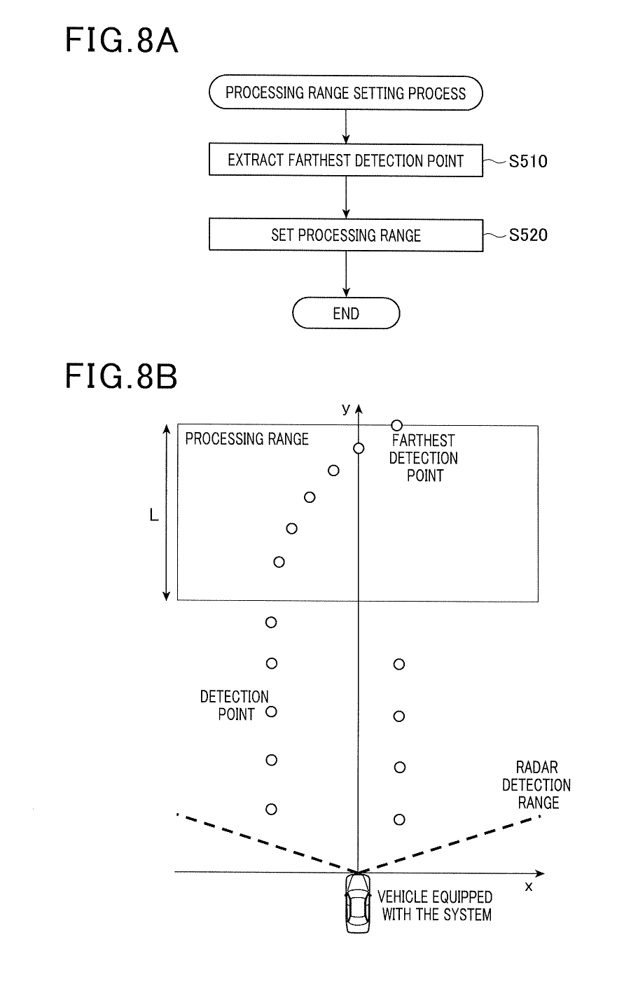

Referring to the flow diagram of FIG. 8A and the bird's eye diagram of FIG. 8B illustrating a processing range, hereinafter is described the processing range setting process.

As shown in FIGS. 8A and 8B, in the processing range setting process, data are read out, first, from the identifying memory of the RAM. Of the detection points included in the read-out data, a detection point located at the farthest position (farthest detection point) is extracted (S510). Then, with reference to the farthest detection point, a processing region is set on the near side of the vehicle, ranging a predetermined distance (e.g., of 50 m) from the farthest detection point (i.e. covering a region L shown in FIG. 8B) (S520).

Then, the processing range setting process is ended. From this process onward, the road shape within the region L is detected using only the detection points that fall within the region L.

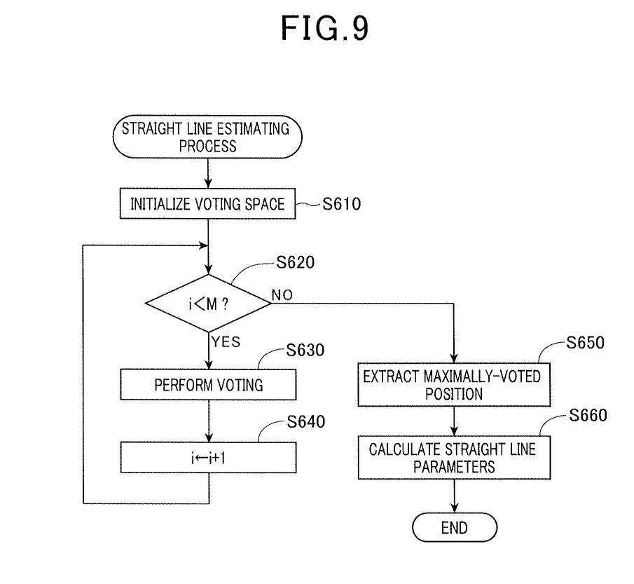

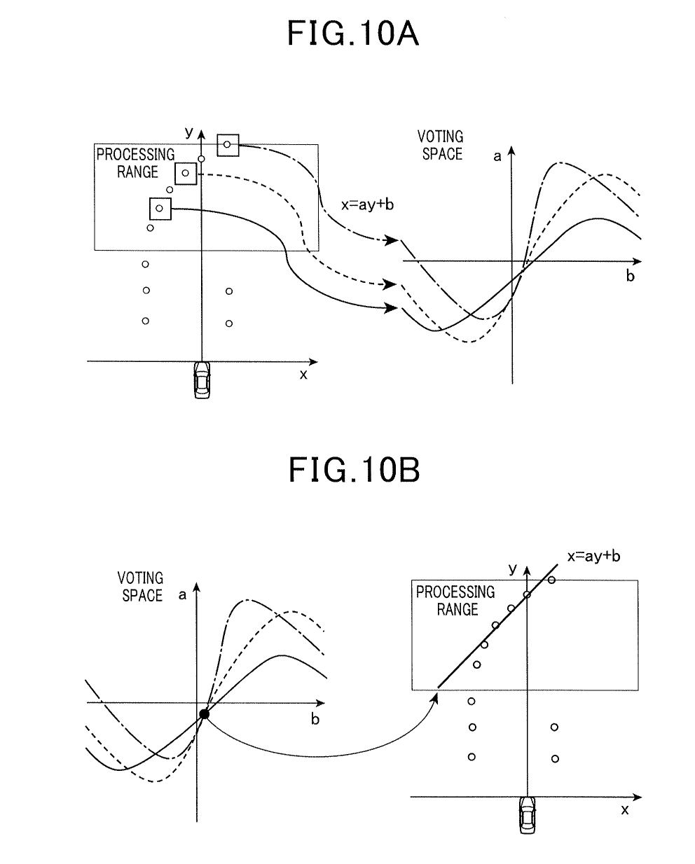

Hereinafter is described the straight-line estimating process referring to the flow diagram of FIG. 9 and the schematic diagrams of FIGS. 10A and 10B. As shown in FIG. 9, in the straight-line estimating process, a voting space is initialized first (S610). The term “voting space” refers to a virtual space which is used for calculating an appropriate curve in the straight-line estimating process or the curved-line estimating process.

It should be appreciated that, in the initialization at step S610, the variable i is reset as well. Then, the variable i is compared with a constant “M” (S620). The constant M here indicates a total number of range data (total number of detection points recorded on the identifying memory) contained in the region to be processed (the region L).

If the variable i is less than the constant M (YES at S620), an i^{th} detection point is selected and then voting is performed for the selected detection point (S630). The term “voting” refers to plotting in the voting space. Specifically, constants in the function that indicates an approximated curve are labeled at respective axes in the voting space. Then, possible combinations of the constants in the function, which pass through the selected detection point, are plotted in the voting space.

More specifically, as shown in FIG. 10A, in the voting space in the straight-line estimating process, the function indicating an approximated curve in an x-y plane where the vehicle is located is established as “x=ay+b” (where “a” and “b” are constants). The constants a and b are labeled at respective axes in the voting space. Then, possible combinations of the constants a and b are plotted in the voting space while the constant a is changed on a predetermined-value-basis (e.g., on a basis of 0.01).

When voting is completed for the selected detection point, the variable i is incremented (S640) and control returns to S620. In this way, voting is performed for every detection point and therefore lots of plots are given in the voting space regarding the individual detection points.

Regarding S620, if the variable i is equal to or more than the constant M (NO at S620), is means that voting has been completed for all of the detection points. Therefore, subsequently, an approximated curve is calculated based on the voting performed. In this calculation, a maximally-voted position is extracted (S650).

As shown in FIG. 10B, the “maximally-voted position” indicates a point (region) in the voting space, at which point the density of the plots regarding the individual detection points is the highest. For example, in order to detect this point (maximally-voted position), the voting space may be divided into matrix blocks on a predetermined-value-basis. Then, the number of plots in each of the divided blocks may be counted.

To this end, the number of plots may be counted for each of the blocks after completing plotting for all of the detection points. Alternatively, the count of each divided block in the voting space may be incremented every time the block is plotted in the course of voting. In the straight-line estimating process and the curved-line estimating process, the number of votes (number of plots) at the maximally-voted position is stored in a predetermined area of the RAM.

Subsequently, the constants a and b (parameters) corresponding to the maximally-voted position are calculated to define the function that indicates a straight line (S660). Then, the straight-line estimating process is ended. In defining the constants a and b at S660, these constants may each be defined by averaging the values of the plotted constants a and the plotted constants b at the maximally-voted position. Alternatively, the divided matrix blocks in the voting space may be correlated to values (representative values) indicating the respective blocks and the representative value of the block where the maximally-voted position falls may be used.

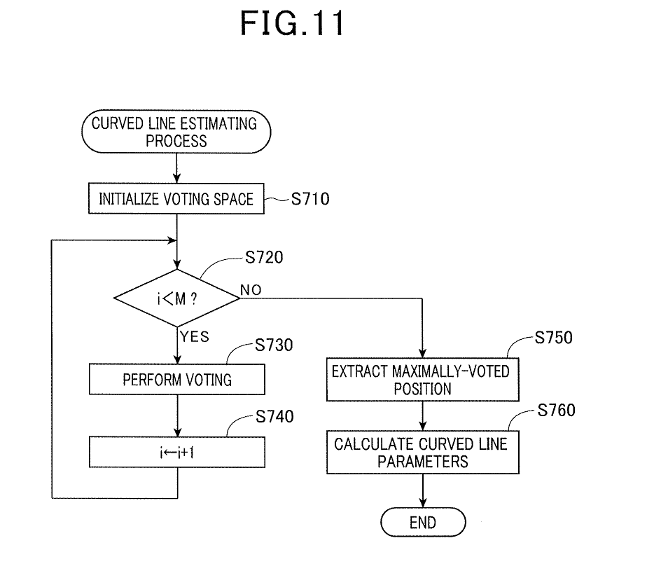

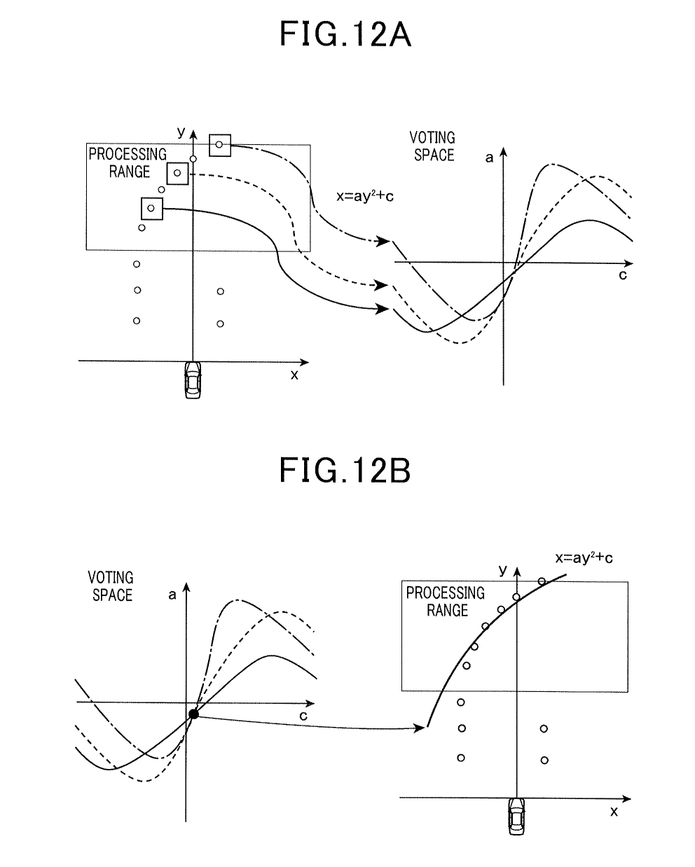

Referring to the flow diagram of FIG. 11 and the schematic diagrams of FIGS. 12A and 12B, hereinafter is described the curved-line estimating process. As shown in FIG. 11, in the curved-line estimating process, a voting space is initialized first (S710). In the initialization at S710, the variable i is also reset. Then, the variable i is compared with a constant M (S720). The constant M has the same value as the previously mentioned constant M.

If the variable i is less than the constant M (YES at S720), an i^{th} detection point is selected and voting is performed for the selected detection point (S730). Voting in the curved-line estimating process is performed as follows. Specifically, as shown in FIG. 12A, a function indicating an approximated curve in an x-y plane where the vehicle is located is established as “x=ay²+c” (where “a” and “c” are constants). The constants a and c are labeled at respective axes in the voting space. Then, possible combinations of the constants a and c are plotted in the voting space while the constant a is changed on a predetermined-value-basis (e.g., on a basis of 0.01).

The function indicating the approximated curve may be a function indicating an arc, an ellipse, or the like. In the present process, the above function is used because at least a straight line and a curved line may only have to be distinguished from each other. Using the above function, the approximated curve can be calculated with a more simplified operation and with a less number of constants. In this case, the curve approximated by the above function can be re-approximated by an arc using only the detection points located near the curve in an optional process using such a technique as least square. Thus, the presence of a curve and the curvature radius of the curve are estimated.

When voting is completed for the selected detection point, the variable i is incremented (S740) and control returns to S720. If the variable i is equal to or more than the constant M at S720 (NO at S720), it means that voting for all of the detection points has been completed. Therefore, subsequently, an approximated curve is calculated based on the voting performed. In this calculation, similar to the straight-line estimating process, a maximally-voted position is extracted (S750) (see FIG. 12B).

Then, the constants a and c (parameters) corresponding to the maximally-voted position are calculated to define a function indicating a curved line (S760). Then, the curved-line estimating process is ended. In calculating the constants a and c, at S760, corresponding to the maximally-voted position, the approach similar to that of the straight-line estimating process may be used.

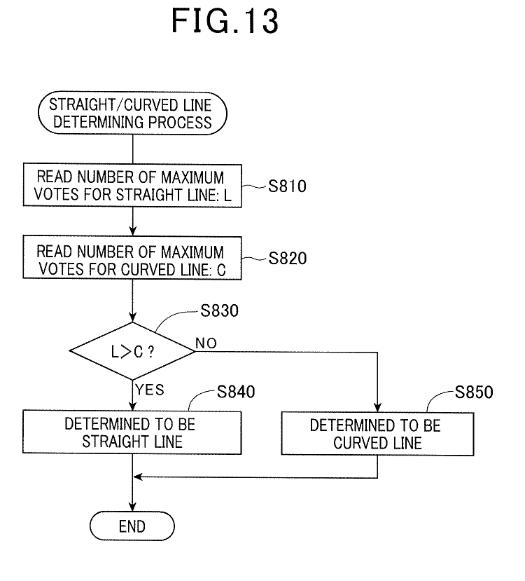

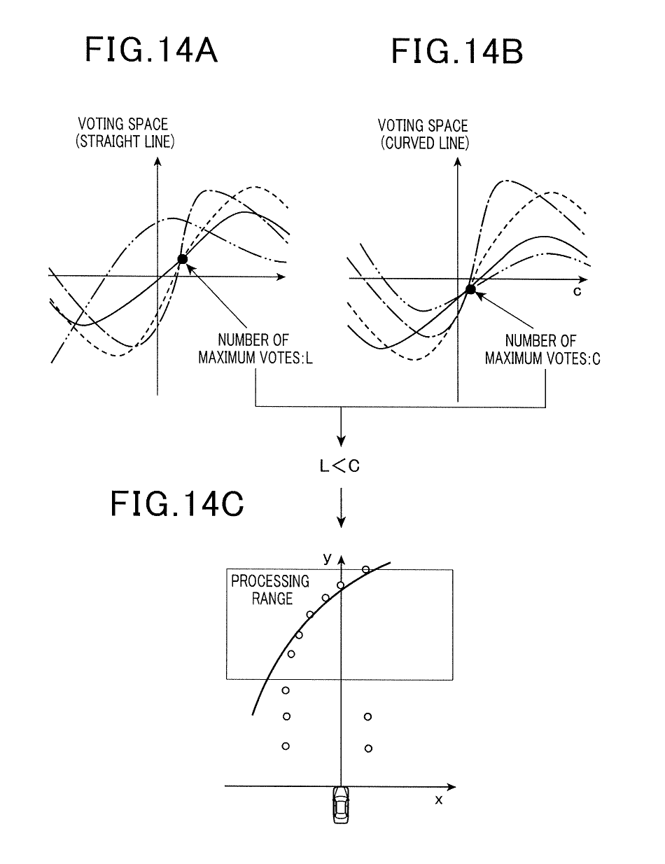

Referring to the flow diagram of FIG. 13 and the schematic diagrams of FIGS. 14A to 14C, hereinafter is described the straight/curved-line determining process. First, in the straight/curved-line determining process, the number of maximum votes L (the number of plots at the maximally-voted position) in the straight-line estimating process and the number of maximum votes C (the number of plots at the maximally-voted position) in the curved-line estimating process are read out from the RAM (S810, S820), and these numbers L and C are compared (S830) (see FIGS. 14A and 14B).

A larger number of maximum votes means that that much of detection points are located closer to the approximated curve. Accordingly, it is determined, at S830, which is proper between the case of assuming the approximated curve to be a straight line (first-order curve) and the case of assuming the approximated curve to be a curved line (second-order curve).

If the number of maximum votes L in the straight-line estimating process is larger than the number of maximum votes C in the curved-line estimating process (YES at S830), the approximated curve is determined to be a straight line. Thus, the function of the approximated curve associated with a straight line is used (S840) and then the straight/curved-line determining process is ended.

If the number of maximum votes L in the straight-line estimating process is equal to or less than the number of maximum votes C in the curved-line estimating process (NO at S830), the approximated curve is determined to be a curved line. Thus, the function of the approximated curve associated with a curved line is used (S850) and then the straight/curved-line determining process is ended (see FIG. 14C).

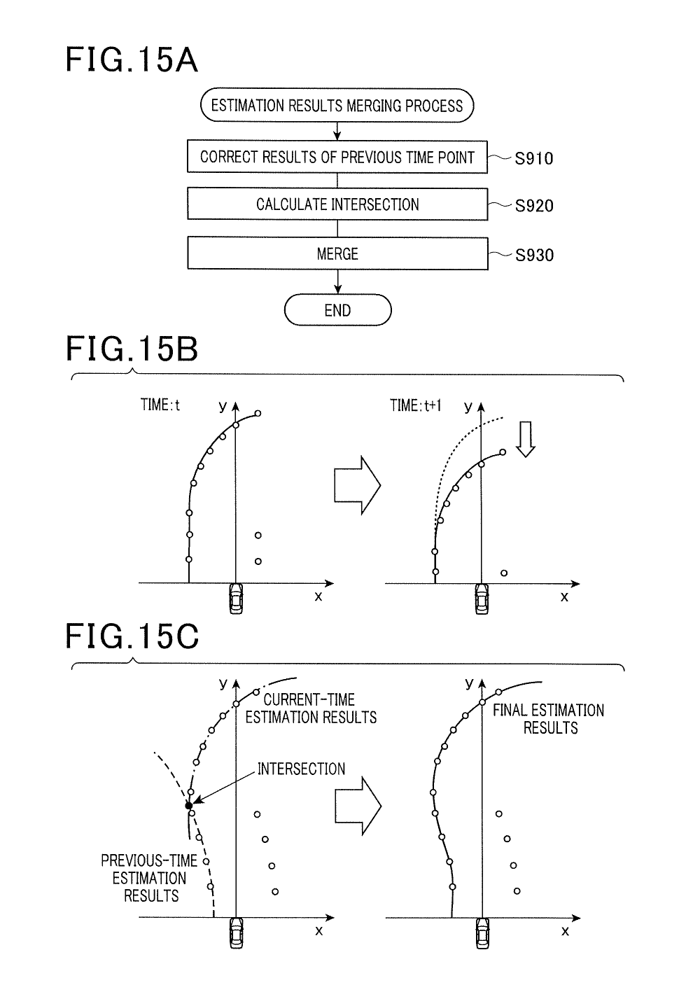

Referring to the flow diagram of FIG. 15A and the schematic diagrams of FIGS. 15B and 15C, hereinafter is described the estimation results merging process. As shown in FIG. 15A, in the estimation results merging process, the results of the previous time point are corrected, first (S910: short-range approximated curve detecting means).

In performing this correction, the processing similar to that of the past data setting process (e.g., see FIG. 5) is used. Specifically, using the processing, an operation is performed, in which the results of the curve approximation of the previous time point obtained by the long-range approximated curve detecting means are corrected to obtain the current position, based on the travel distance of the vehicle. As shown in FIG. 15B, in this operation, the results of curve approximation at a previous time t are corrected to obtain a curve estimated at the current time point (t+1). The results of this operation are recorded on the identifying memory and the past superposing memory in the RAM.

Subsequently, an intersection (closest point) of the two approximated curves is calculated (S920: road-shape defining means), the two approximated curves being the approximated curve (long-range approximated curve) of the current time point calculated in the straight/curved-line determining process and the approximated curve (short-range approximated curve) calculated at S910. Then, these approximated curves are merged (or connected) so as to be a smooth curve (S930: road-shape defining means).

In merging (or connecting) the curves, an optional technique, such as smoothing or least square, may be used.

In the estimation system 1 as specifically described so far, the road-shape estimation unit 10 receives reflected waves of electromagnetic waves that have been applied in the forward direction of the vehicle to thereby acquire detection results in the form of a plurality of detection points that are candidates indicating road edges. Then, an approximated curve is detected regarding the plurality of detection points whose distance from the vehicle is equal to or more than a predetermined value. Also, an approximated curve is detected regarding the plurality of detection points whose distance from the vehicle is less than a predetermined value. Then, the detected approximated curves are merged to define a road shape.

According to the road-shape estimation unit 10, a road shape is detected only based on detection points. Accordingly, compared with the case where geographical data, for example, are required, a road shape is estimated with a simple configuration. Also, a plurality of approximated curves are calculated by dividing a region into blocks according to the distance from the vehicle to detection points. Accordingly, compared with the case where an entire region is detected as a single approximated curve, the influence in the change of road shape is unlikely to be caused between a short-range region and a long-range region.

Therefore, the accuracy of detecting an approximated curve is enhanced. It should be appreciated that the distance from the vehicle to each detection point is reliably detected using a configuration for detecting reflected waves.

Further, the road shape estimation unit 10 plots possible combinations of constants for each of the detection points in a predetermined function indicating an approximated curve passing through the detection points, in a voting space where values of the constants or values associated with the constants are labeled at respective axes. Then, the road shape estimation unit 10 uses the combinations of the constants at a position in the voting space, where the density of the plots is the highest. Thus, by performing voting, the road shape estimation unit 10 detects an approximated curve.

According to the road shape estimation unit 10, by performing voting, detection points not indicating road edges are effectively removed to obtain only the detection points indicating road edges. Accordingly, accuracy is enhanced in detecting an approximated curve that indicates a road edge. Also, in performing voting, it is not necessary to identify whether a detection point indicates a pedestrian, a vehicle, a road edge, or the like, whereby the processing of voting is simplified.

The road-shape estimation unit 10 performs both of the voting for detecting a first-order curve and the voting for detecting a second-order curve. Then, the road-shape estimation unit 10 uses, as an approximated curve, the combinations of constants with the highest density of the plots in both of the voting spaces.

According to the road-shape estimation unit 10, a road shape is identified to be straight or curved.

Further, the road-shape estimation unit 10 acquires the detection results of the behaviors of the vehicle. Then, regarding an approximated curve detected in the past, the road-shape estimation unit 10 estimates the position of the approximated curve when the vehicle has traveled and approached the detection points, based on the acquired behaviors of the vehicle, and uses the results of the estimation as an approximated curve.

According to the road-shape estimation unit 10, an approximated straight line in a short-range region (region whose distance from the vehicle is less than a predetermined value) is detected with simple processing.

Also, the road-shape estimation unit 10 repeatedly acquires detection results regarding a plurality of detection points. Then, based on the behaviors of the vehicle, the road-shape estimation unit 10 calculates, for each of the detection points, the travel distance of the vehicle from the time point when the detection point was acquired in the past to the time point when the latest detection point has been acquired. Then, the road-shape estimation unit 10 corrects the position of each of the detection points in the past by an amount corresponding to the travel distance of the vehicle to add the corrected position to the latest detection point.

According to the road-shape estimation unit 10, moving objects, such as preceding vehicles and pedestrians, are lightly weighted because the positions of these objects will change, while stationary objects, such as road edges, are heavily weighted. As a result, the moving objects are easily removed in calculating an approximated curve.

Further, in the road-shape estimation unit 10, a predetermined region is scanned while electromagnetic waves are intermittently applied toward the region in the forward direction of the vehicle. The road-shape estimation unit 10 then receives the reflected waves to acquire detection results of detection points. Meanwhile, the road-shape estimation unit 10 calculates the travel distance of the vehicle from each time point when electromagnetic waves are applied to the region until a certain time point when scanning is ended, based on the behaviors of the vehicle. Then, the road-shape estimation unit 10 corrects the position of each of the acquired detection points by an amount corresponding to the travel distance of the vehicle and detects an approximated curve using the corrected positions of the detection points.

For example, the road-shape estimation unit 10 may be used with a laser radar which is configured to obtain detection points by scanning a predetermined region in the forward direction of the vehicle while intermittently applying electromagnetic waves to the region and by receiving the reflected waves. Being used with a laser radar having such a configuration, the road-shape estimation unit 10 is able to correct the delay time caused in the detection and therefore the accuracy of detecting a road width and a road shape is maintained.

According to the road-shape estimation unit 10, an approximated curve inside a region L is detected separately from an approximated curve outside the region L. Accordingly, change of the road shape is detected by detecting the difference between these approximated curves.

### MODIFICATIONS

The present invention is not limited to the embodiment described above but may variably modified as far as the modifications fall within the spirit of the present invention.

For example, in the above embodiment, an approximated curve has been detected by performing voting. Alternative to this, an approximated curve may be detecting using a different technique, such as least square.

Also, in performing voting in the above embodiment, constants in a function indicating an approximated curve have been labeled at respective axes in a voting space. Alternative to this, values associated with constants may be labeled at respective axes in a voting space. For example, the values associated with constants may be the constants related to a polar coordinate into which the function has been converted.

What is claimed is:

1. An apparatus for estimating a shape of a road on which a vehicle travel, the apparatus being mounted on the vehicle, the apparatus comprising:
first receiving means for receiving information indicative of a plurality of detection points which are given as a plurality of candidates for edges of the road viewed forward from the vehicle, by transmitting an electromagnetic wave toward a space viewed forward from the vehicle and receiving a reflected wave of the transmitted electromagnetic wave;
determining means for determining whether or not a distance between each of the plurality of detection points and the vehicle is equal to or larger than a predetermined value;
first detecting means for detecting a first approximated curve for each of a plurality of detection points having the distance equal to larger than the predetermined value among the acquired plurality of detection points;
second detecting means for detecting a second approximated curve for each of a plurality of detection points having the distance less than the predetermined value among the acquired plurality of detection points; and
estimating means for estimating the shape of the road by merging the first and second approximated curves detected by the first and second detecting means.

2. The apparatus of claim 1, wherein the first detecting means includes
means for plotting, every one of the detecting points, combinations of a plurality of constants available in a predetermined function indicating an approximated curve passing through each of the detection points, in a voting space defined by axes representing either values of the constants or values related to the constants; and
means for obtaining the approximated curve by performing a voting process in which a combination of the constants whose plots has the highest density in the voting space is employed as the first approximated curve for each of the detection points.

3. The apparatus of claim 2, wherein the voting process includes a first voting process detecting a first-order curve in a first voting space and a second voting process detecting a second-order curve in a second voting space, the first-order and second-order curves belonging to the approximated curve, the first and second voting spaces belonging to the voting space, and
the obtaining means is configured to employ, as the first approximated curve, the combination of the constants whose plots has the highest density in both the first and second voting spaces.

4. The apparatus of claim 1, comprising
second receiving means for receiving information indicative of behavior of the vehicle,
wherein the second detecting means includes
means for estimating, as the second approximated curve, a position of the second approximated curve where the first approximated curve detected by the first detecting means in the past approaches the detection points while the vehicle travels, based on the received information indicative of the behavior of the vehicle, and
means for employing the second approximated curve based on an estimated position of the second approximated curve.

5. The apparatus of claim 1, wherein the first receiving means is configured to repeatedly receive the information indicative of the plurality of detection points,
the apparatus further comprising
second receiving means for receiving information indicative of behavior of the vehicle;
calculation means for calculating an amount of travel of the vehicle during a period of time from a past detection time of each of the detection points to a latest detection time of each of the detection points, based on the received information indicative of the behavior of the vehicle;
correction means for positionally correcting the past detection points based on the calculated amount of travel of the vehicle; and
superposition means for superposing the positionally corrected detection points on the latest detection points.

6. The apparatus of claim 1, wherein the first receiving means is configured to receive the information indicative of the plurality of detection points, the information being detected by intermittently transmitting an electromagnetic wave ahead of the vehicle to scan a given spatial range ahead and viewed from the vehicle and receiving a reflected electromagnetic wave thereof,
the apparatus further comprising
second receiving means for receiving information indicative of behavior of the vehicle;
travel amount calculating means for calculating, every time when the electromagnetic wave is transmitted, an amount of travel of the vehicle during a given interval of time including at least a time necessary from transmitting the electromagnetic wave to receiving the reflected electromagnetic wave, based on the received information indicative of the behavior of the vehicle;
position correcting means for correcting the positions of the detection points depending on the calculated amounts of travel of the vehicle; and
means for ordering the first and second detecting means to detecting the first and second approximated curves based on the corrected positions of the detection points.

7. The apparatus of claim 2, comprising
second receiving means for receiving information indicative of behavior of the vehicle,
wherein the second detecting means includes
means for estimating, as the second approximated curve, a position of the second approximated curve where the first approximated curve detected by the first detecting means in the past approaches the detection points while the vehicle travels, based on the received information indicative of the behavior of the vehicle, and
means for employing the second approximated curve based on an estimated position of the second approximated curve.

8. The apparatus of claim 2, wherein the first receiving means is configured to repeatedly receive the information indicative of the plurality of detection points,
the apparatus further comprising
second receiving means for receiving information indicative of behavior of the vehicle;
calculation means for calculating an amount of travel of the vehicle during a period of time from a past detection time of each of the detection points to a latest detection time of each of the detection points, based on the received information indicative of the behavior of the vehicle;
correction means for positionally correcting the past detection points based on the calculated amount of travel of the vehicle; and
superposition means for superposing the positionally corrected detection points on the latest detection points.

9. The apparatus of claim 2, wherein the first receiving means is configured to receive the information indicative of the plurality of detection points, the information being detected by intermittently transmitting an electromagnetic wave ahead of the vehicle to scan a given spatial range ahead and viewed from the vehicle and receiving a reflected electromagnetic wave thereof,
the apparatus further comprising
second receiving means for receiving information indicative of behavior of the vehicle;
travel amount calculating means for calculating, every time when the electromagnetic wave is transmitted, an amount of travel of the vehicle during a given interval of time including at least a time necessary from transmitting the electromagnetic wave to receiving the reflected electromagnetic wave, based on the received information indicative of the behavior of the vehicle;
position correcting means for correcting the positions of the detection points depending on the calculated amounts of travel of the vehicle; and
means for ordering the first and second detecting means to detecting the first and second approximated curves based on the corrected positions of the detection points.

10. The apparatus of claim 3, comprising
second receiving means for receiving information indicative of behavior of the vehicle,
wherein the second detecting means includes
means for estimating, as the second approximated curve, a position of the second approximated curve where the first approximated curve detected by the first detecting means in the past approaches the detection points while the vehicle travels, based on the received information indicative of the behavior of the vehicle, and
means for employing the second approximated curve based on an estimated position of the second approximated curve.

11. The apparatus of claim 3, wherein the first receiving means is configured to repeatedly receive the information indicative of the plurality of detection points,
the apparatus further comprising
second receiving means for receiving information indicative of behavior of the vehicle;
calculation means for calculating an amount of travel of the vehicle during a period of time from a past detection time of each of the detection points to a latest detection time of each of the detection points, based on the received information indicative of the behavior of the vehicle;
correction means for positionally correcting the past detection points based on the calculated amount of travel of the vehicle; and
superposition means for superposing the positionally corrected detection points on the latest detection points.

12. The apparatus of claim 3, wherein the first receiving means is configured to receive the information indicative of the plurality of detection points, the information being detected by intermittently transmitting an electromagnetic wave ahead of the vehicle to scan a given spatial range ahead and viewed from the vehicle and receiving a reflected electromagnetic wave thereof,
the apparatus further comprising
second receiving means for receiving information indicative of behavior of the vehicle;
travel amount calculating means for calculating, every time when the electromagnetic wave is transmitted, an amount of travel of the vehicle during a given interval of time including at least a time necessary from transmitting the electromagnetic wave to receiving the reflected electromagnetic wave, based on the received information indicative of the behavior of the vehicle;
position correcting means for correcting the positions of the detection points depending on the calculated amounts of travel of the vehicle; and
means for ordering the first and second detecting means to detecting the first and second approximated curves based on the corrected positions of the detection points.

13. A method of estimating a shape of a road on which a vehicle travel, the method comprising steps of:
intermittently radiating an electromagnetic wave ahead of the vehicle to scan a given spatial range ahead and viewed from the vehicle and receiving a reflected electromagnetic wave thereof;
receiving information indicative of a plurality of detection points which are given as a plurality of candidates for edges of the road viewed forward from the vehicle, from the received reflected electromagnetic wave;
determining whether or not a distance between each of the plurality of detection points and the vehicle is equal to or larger than a predetermined value;
first detecting a first approximated curve for each of a plurality of detection points having the distance equal to larger than the predetermined value among the acquired plurality of detection points;
second detecting a second approximated curve for each of a plurality of detection points having the distance less than the predetermined value among the acquired plurality of detection points; and
estimating means for estimating the shape of the road by merging the first and second approximated curves detected by the first and second detecting steps.

14. A system for estimating a shape of a road on which a vehicle travel, the system being mounted in the vehicle, the system comprising:
a sensor that intermittently radiates an electromagnetic wave ahead of the vehicle to scan a given spatial range ahead and viewed from the vehicle and receive a reflected electromagnetic wave thereof;
first receiving means for receiving information indicative of a plurality of detection points which are given as a plurality of candidates for edges of the road viewed forward from the vehicle, from the received reflected electromagnetic wave;
determining means for determining whether or not a distance between each of the plurality of detection points and the vehicle is equal to or larger than a predetermined value;
first detecting means for detecting a first approximated curve for each of a plurality of detection points having the distance equal to larger than the predetermined value among the acquired plurality of detection points;
second detecting means for detecting a second approximated curve for each of a plurality of detection points having the distance less than the predetermined value among the acquired plurality of detection points; and
estimating means for estimating the shape of the road by merging the first and second approximated curves detected by the first and second detecting means.
